(19) United States
(12) Patent Application Publication
(10) Pub. No.: US 2024/0161621 A1
(43) Pub. Date: May 16, 2024

(54) SYSTEMS THAT PREDICT ACCIDENTS AND AMELIORATE PREDICTED ACCIDENTS

(71) Applicant: GridMatrix, Inc., Cupertino, CA (US)

(72) Inventors: Raffi Mesrobian, Los Angeles, CA (US); David Von Dollen, Beaverton, OR (US)

(21) Appl. No.: 18/489,592

(22) Filed: Oct. 18, 2023

Related U.S. Application Data
(60) Provisional application No. 63/424,626, filed on Nov. 11, 2022.

(51) Int. Cl. G08G 1/16; G08G 1/01

(52) U.S. Cl. CPC G08G 1/164; G08G 1/0116; G08G 1/0129; G08G 1/0133; G08G 1/0145; G08G 1/166

(57) ABSTRACT

A system ameliorates accidents predicted by correlating traffic and weather monitoring. Traffic data and weather data are obtained. One or more accidents are predicted by correlating the traffic data and weather data to historical traffic and weather accident data. One or more actions are then taken to ameliorate the accident. This may include providing one or more alerts regarding the accident, providing one or more visualizations regarding the accident and/or otherwise associated with the accident, controlling traffic signals, generating recommendations to change traffic systems, route emergency services, and/or otherwise act to ameliorate the accident.

### CROSS-REFERENCE TO RELATED APPLICATION

This application is a nonprovisional and claims the benefit under 35 U.S.C. § 119(e) of U.S. Provisional Patent Application No. 63/424,626, filed Nov. 11, 2022, titled “Systems That Predict Accidents and Ameliorate Predicted Accidents”, the contents of which are incorporated herein by reference as if fully disclosed herein.

### FIELD

The described embodiments relate generally to traffic monitoring and analysis. More particularly, the present embodiments relate to ameliorating accidents predicted by correlating traffic and weather monitoring.

### BACKGROUND

All population areas experience traffic. Traffic may be motorized, non-motorized, and so on. Traffic may include cars, trucks, pedestrians, scooters, bicycles, and so on. Traffic appears to only increase as the population of the world continues to increase.

Some population areas, such as cities, use cameras and/or other traffic monitoring devices to capture data about traffic. This data may be used to evaluate congestion, traffic signal configurations, road layout, and so on.

### Overview

The present disclosure relates to ameliorating accidents predicted by correlating traffic and weather monitoring. Traffic data and weather data may be obtained. One or more accidents may be predicted by correlating the traffic data and weather data to historical traffic and weather accident data. One or more actions may be then taken to ameliorate the accident. This may include providing one or more alerts regarding the accident, providing one or more visualizations regarding the accident and/or otherwise associated with the accident, controlling traffic signals, generating recommendations to change traffic systems, route emergency services, and/or otherwise act to ameliorate the accident.

In various embodiments, a system for ameliorating accidents predicted by correlating traffic and weather monitoring includes a non-transitory storage medium that stores instructions and a processor. The processor executes the instructions to obtain traffic data; structure the traffic data into structured data; derive metrics from the structured traffic data; obtain weather data; correlate accidents, the metrics, and the weather data to generate traffic and weather accident data; obtain current traffic data; obtain current weather data; predict an accident by correlating the current traffic data and the current weather data with the traffic and weather accident data; and take an action to ameliorate the accident.

In some examples, the action includes routing emergency services. In a number of examples, the action includes providing an alert. In various examples, the action includes controlling a traffic signal.

In a number of examples, the processor predicts the accident by determining that a particular intersection has an increased likelihood of the accident due to a correlation between a current weather condition and a current traffic condition. In some implementations of such examples the current weather condition includes a slick road. In a number of implementations of such examples, the current traffic condition includes a particular vehicle volume.

In some embodiments, a system for ameliorating accidents predicted by correlating traffic and weather monitoring includes a non-transitory storage medium that stores instructions and a processor. The processor executes the instructions to obtain traffic data, obtain weather data, predict an accident by correlating the traffic data and the weather data with historical traffic and weather accident data, and take an action to ameliorate the accident.

In a number of examples, the processor generates the historical traffic and weather accident data using obtained data regarding traffic, weather, and accidents. In various examples, the action includes providing a visualization dashboard that depicts information associated with the accident.

In some examples, the processor receives the traffic data from at least one traffic monitoring device. In a number of implementations of such examples, the at least one traffic monitoring device includes at least one of a still image, a video camera, and a light detection and ranging sensor. In some implementations of such examples, the system includes the at least one traffic monitoring device.

In various examples, the processor uses a cloud computing arrangement to analyze the traffic data.

In a number of embodiments, a method for ameliorating accidents predicted by correlating monitoring includes obtaining traffic data using at least one processing unit, structuring the traffic data into structured data using the at least one processing unit, deriving metrics from the structured traffic data using the at least one processing unit, obtaining other data using the at least one processing unit, predicting an accident using the at least one processing unit by correlating the metrics and the other data with historical traffic and other accident data, and taking an action to ameliorate the accident using the at least one processing unit.

In various examples, the data is weather data. In some examples, the metrics include at least one of vehicle volume, average speed, movement status, distance travelled, queue length, pedestrian volume, non-motor volume, and light status on arrival. In a number of examples, the metrics include at least one of arrival phase, route through intersection, light times, and near misses.

In some examples, the structuring the traffic data into the structured data includes identifying objects in one or more frames. In various examples, the deriving the metrics from the structured traffic data includes tracking objects between one or more frames.

### BRIEF DESCRIPTION OF THE DRAWINGS

The disclosure will be readily understood by the following detailed description in conjunction with the accompanying drawings, wherein like reference numerals designate like structural elements.

FIG. 1 depicts a first example system for ameliorating accidents predicted by correlating traffic and weather monitoring.

FIG. 2 depicts a flow chart illustrating a first example method for ameliorating accidents predicted by correlating traffic and weather monitoring. This method may be performed by the system of FIG. 1.

FIG. 3 depicts a flow chart illustrating a second example method for ameliorating accidents predicted by correlating traffic and weather monitoring. This method may be performed by the system of FIG. 1.

FIG. 4 depicts a group of intersections with traffic monitoring devices.

FIG. 5 depicts a flow chart illustrating a third example method for ameliorating accidents predicted by correlating traffic and weather monitoring. This method may be performed by the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

The raw data from one or more traffic devices may only be able to provide so much insight into the traffic. Processing of the data may be more useful, providing the ability to visualize various metrics about the traffic, enable adaptive traffic signal control, predict traffic congestion and/or accidents, aggregate data from multiple population areas for various uses, such as in the auto insurance industry, rideshare industry, logistics industry, autonomous vehicle original equipment manufacturer industry, and so on.

Further, weather may influence traffic behavior. For example, the likelihood of accidents may increase when rain makes road conditions slippery. However, such generalities typically provide only so much assistance for ameliorating potential accidents, relying on the traffic itself to exert more care when merited by weather conditions. Analysis of historical traffic and weather accident data may provide significantly more granular information. By correlating historical traffic, weather, and accident data to generate such historical traffic and weather accident data, current traffic and weather information may be correlated thereto in order to predict increased likelihoods of accidents at specific intersections and/or other traffic places in order to trigger performance of more specific actions that more effectively ameliorate the predicted accidents. Use of thresholds may be used to control when such increased likelihoods should trigger performance of ameliorative actions and when the effort of such actions might not be worthwhile to ameliorate smaller increased risks.

For example, historical traffic and weather accident data may indicate that a particular intersection has a 65% higher likelihood of accidents corresponding to left turns when at least an inch of rain has fallen within the last half hour and traffic volume exceeds a certain amount. Traffic and weather data may be compared to the historical traffic and weather accident data to determine that an inch of rain has fallen in the last half hour and the traffic volume exceeds the certain amount. In response, traffic signals may be controlled to reroute traffic from other intersections that lead into the particular intersection to reduce the traffic volume until the predicted likelihood of accidents decreases below a threshold, such as 15%.

By way of another example, historical traffic and weather accident data may indicate that a particular intersection has a 35% higher likelihood of accidents corresponding to stuck vehicles when ice is on the road. Traffic and weather data may be compared to the historical traffic and weather accident data to determine that ice is on the roads. In response, emergency services may be routed to be present in the vicinity in order to get vehicles unstuck and keep traffic moving.

The following disclosure relates to ameliorating accidents predicted by correlating traffic and weather monitoring. Traffic data and weather data may be obtained. One or more accidents may be predicted by correlating the traffic data and weather data to historical traffic and weather accident data. One or more actions may be then taken to ameliorate the accident. This may include providing one or more alerts regarding the accident, providing one or more visualizations regarding the accident and/or otherwise associated with the accident, controlling traffic signals, generating recommendations to change traffic systems, route emergency services, and/or otherwise act to ameliorate the accident.

In this way, the system may be able to perform accident predication and/or amelioration that the system would not previously have been able to perform absent the technology disclosed herein. This may improve system operation by consuming fewer hardware and/or software resources ameliorating predicted accidents rather than having to respond to actual accidents, as well as improve user interfaces by providing alerts and/or visualizations associated with predicted accidents that users may not otherwise be able to access. This may also enable the system to operate more efficiently while consuming fewer hardware and/or software resources as more resource consuming techniques could be omitted. Further, a variety of components may be omitted while still enabling traffic monitoring, analysis, and prediction, reducing unnecessary hardware and/or software components, and providing greater system flexibility.

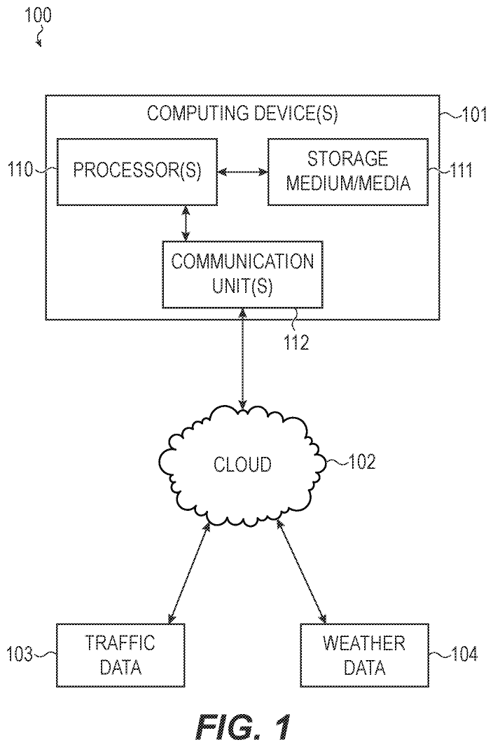

These and other embodiments are discussed below with reference to FIGS. 1-5. However, those skilled in the art will readily appreciate that the detailed description given herein with respect to these Figures is for explanatory purposes only and should not be construed as limiting.

FIG. 1 depicts a first example system 100 for ameliorating accidents predicted by correlating traffic and weather monitoring. The system 100 may include one or more computing devices 101 that interact with one or more cloud computing arrangements 102 to ameliorate accidents predicted by correlating traffic and weather monitoring.

The system 100 may correlate historical traffic, weather, and accident data to generate historical traffic and weather accident data. The system 100 may correlate current traffic and weather information thereto in order to predict increased likelihoods of accidents at specific intersections and/or other traffic places in order to trigger performance of more specific actions that more effectively ameliorate the predicted accidents. The system 100 may use thresholds to control when such increased likelihoods should trigger performance of ameliorative actions and when the effort of such actions might not be worthwhile to ameliorate smaller increased risks.

For example, historical traffic and weather accident data may indicate that a particular intersection has a 65% higher likelihood of accidents corresponding to left turns when at least an inch of rain has fallen within the last half hour and traffic volume exceeds a certain amount. The system 100 may compare traffic and weather data to the historical traffic and weather accident data to determine that an inch of rain has fallen in the last half hour and the traffic volume exceeds the certain amount. In response, the system 100 may control traffic signals to reroute traffic from other intersections that lead into the particular intersection to reduce the traffic volume until the predicted likelihood of accidents decreases below a threshold, such as 15%.

By way of another example, historical traffic and weather accident data may indicate that a particular intersection has a 35% higher likelihood of accidents corresponding to stuck vehicles when ice is on the road. The system 100 may compare traffic and weather data to the historical traffic and weather accident data to determine that ice is on the roads. In response, the system 100 may route emergency services to be present in the vicinity in order to get vehicles unstuck and keep traffic moving.

The system 100 may obtain traffic data and weather data. The system 100 may obtain traffic and/or weather data from one or more traffic devices, and/or from traffic data 103 and/or weather data 104 sources such as NYC Open Data, the National Centers for Environmental Information, and so on. The system 100 may predict one or more accidents by correlating the traffic data and weather data to historical traffic and weather accident data. The system 100 may take one or more actions to ameliorate the accident. This may include providing one or more alerts regarding the accident, providing one or more visualizations regarding the accident and/or otherwise associated with the accident, controlling traffic signals, generating recommendations to change traffic systems, routing emergency services, and/or otherwise acting to ameliorate the accident.

In this way, the system 100 may be able to perform accident predication and/or amelioration that the system would not previously have been able to perform absent the technology disclosed herein. This may improve system 100 operation by consuming fewer hardware and/or software resources ameliorating predicted accidents rather than having to respond to actual accidents, as well as improve user interfaces by providing alerts and/or visualizations associated with predicted accidents that users may not otherwise be able to access. This may also enable the system to operate more efficiently while consuming fewer hardware and/or software resources as more resource consuming techniques could be omitted. Further, a variety of components may be omitted while still enabling traffic monitoring, analysis, and prediction, reducing unnecessary hardware and/or software components, and providing greater system flexibility.

The system 100 may perform traffic monitoring, analysis, and prediction. Traffic data may be obtained, such as via a gateway from one or more traffic monitoring devices (such as one or more intersection and/or other still image and/or video cameras, Light Detection and Ranging sensors (or “LiDAR”), loops, radar, weather data, Internet of Things sensors, fleet vehicles, traffic controllers and/or other city and/or other population area supplied data devices, navigation app data, connected vehicles, and so on). One or more data processing pipelines implemented by the system 100 may perform object detection and classification using the data. For example, objects may be detected and classified as cars, trucks, buses, pedestrians, light vehicles, heavy vehicles, non-motor vehicles, and so on. Objects may be assigned individual identifiers, identifiers by type, and so on. The data processing pipeline devices may determine and/or output structured data using the detected and classified objects. The data processing pipeline may calculate one or more metrics using the structured data. For example, the metrics may involve vehicle volume, vehicle volume by vehicle type, average speed, movement status, distance travelled, queue length, pedestrian volume, non-motor volume, light status on arrival, arrival phase, route through intersection, light times, near misses, longitude, latitude, city, state, country, and/or any other metrics that may be calculated using the structured data. Such metrics may be correlated to weather data, accident data, and/or historical traffic and weather accident data in order to predict one or more accidents.

The data processing pipeline may prepare the processed data for visualization and/or other uses. The data processing pipeline may present the prepared processed data via one or more dashboards and/or otherwise use the prepared processed data.

By way of example, a data pipeline may begin with a raw, real-time video feed from an intersection camera that is in use by a city department of transportation. This video may then be passed through a secure gateway to a cloud based processing pipeline (such as Amazon Web Services™ and/or any other cloud vendor, service, and/or implementation).

The pipeline's first instance may allow for rapid development of machine learning and computer vision applications within the cloud provider's on-demand infrastructure. It may run object detection and classification deep learning models on the video. Examples of such video detection and classification algorithms include, but are not limited to, YOLOv4+DeepSORT, YOLOv4+DeepMOT, and so on.

After this detection and classification layer has run, the pipeline may output structured data, such as the position, trajectory, count, and type of motorized and non-motorized road users. The structured data from this module may be stored in a cloud instance and then be passed to a second instance that may calculate the intersection metrics.

These metrics may be stored in tables to minimize latency and storage size. These tables may include an intersection table, a vehicle table, and an approaches table, and so on.

This processed data may be held in an additional cloud instance, and then exported (such as in JSON files) to a data warehouse where it may be further optimized for visualization. After, the processed data may be written to a live model (such as SiSense™, an enterprise dashboard provider) that may allow for the data to be visualized in real time and/or a SiSense™ ElastiCube™ for later retrieval and visualization of time-based metrics.

After the data has been stored in these instances, it may be visualized as a dashboard, which may be shown as camera locations in a city. A user may click in (and/or otherwise select) and see specific metrics about an intersection's health and performance.

Although the above is described in the context of supporting a visualization dashboard, it is understood that this is an example. In various implementations, such data processing may be used to support adaptive traffic signal control, predicting traffic congestion and accidents, as well as productizing aggregated data from multiple cities for private sector use in the auto insurance, rideshare, logistics, autonomous vehicle original equipment manufacturer spaces, and so on.

Although the above is described in the context of intersection cameras, it is understood that this is an example. In various implementations, other data sources beyond data extracted from intersection video feeds may be used. This may include weather, Internet of Things sensors, LiDAR sensors, fleet vehicles, city suppliers (e.g. traffic controller), navigation app data, connected vehicle data, and so on.

Although the above illustrates and describes performance of functions like detection and classification, determination of structured data, and so on, it is understood that this is an example. In various implementations, one or more such functions may be omitted without departing from the scope of the present disclosure.

For example, in some implementations, data that has already been detected and classified may be obtained. Various metrics may be calculated from such, similar to above, which may then be prepared for visualization and/or visualized and/or otherwise used similar to above.

In various implementations, frames of a raw, real-time video feed from an intersection camera and/or other traffic data may be obtained (though it is understood that this is an example and that in other examples other data, such as point cloud LiDAR data, may be obtained and used). Detection and classification may be performed on each frame to identify and classify the objects in the frame. Structured data may then be determined for the objects detected. For example, a frame number may be determined for a frame, an intersection identifier may be determined for a frame, a unique tracker identifier may be assigned to each object detected, the class of the object may be determined (such as person, car, truck, bus, motorbike, bicycle, and so on), coordinates of the object detected in the frame may be determined (which may be determined with reference to known coordinates of the intersection and/or the intersection camera, such as camera longitude, latitude, city, state, country, and so on) (such as the minimum and maximum x positions of the object, the minimum and maximum y positions of the object, and so on), and the like.

Various metrics may be calculated from the structured data mentioned above. For example, a bounding box may be calculated for the object based on one or more x and/or y positions for the object. By way of another example, one or more geometric centers of the object's bounding box may be calculated for the object in the x and/or y coordinate (such as an x min, a y min, and so on). By way of still another example, an intersection approach that the object is currently on may be calculated, such as based on a position of the object and a position of the center of the intersection.

Further, other structured data may be determined from the frames. For example, one or more time stamps associated with frames may be determined and/or associated with other structured data, such as to determine a time at which an object was at a determined x and/or y position. By way of another example, a light phase for the frame may be determined (such as whether a traffic light in the frame is green, red, and so on), though this may instead be determined by means other than image analysis (such as time-stamped traffic light data that may be correlated to a frame time stamp). This may be used to determine the traffic light phase when an object arrived at the intersection, such as by correlating a traffic light phase determined for a frame along with a determination that an object arrived at the intersection in the frame. In yet another example, data for an approach and/or intersection associated with a frame may be determined (such as based on a uniform resource locator of the video feed and/or any other intersection camera identifier associated with the frame, an approach identifier associated with the frame, an intersection identifier associated with the frame, and so on).

The structured data determined for an object in a frame may be used with the structured data determined for the object in other frames to calculate various metrics. For example, the difference between one or more x and/or y positions for the object (such as the difference and/or distance between x or y midpoints of the object's bounding box) in different frames (such as in a current and a previous frame) may be calculated. Such difference in position between frames, along with times respectively associated with the frames (such as from one or more time-stamps) may be used to calculate one or more metrics associated with the speed of the object (such as an average speed of the object during the video feed (such as in miles per hour and/or other units), cumulative speed, and so on). Such difference in position between frames may also be used to calculate various metrics about the travel of the object (such as the direction of travel between frames, how the object left an intersection, whether or not the object made a right on red, and so on). By way of another example, structured data from multiple frames may be used to determine a status of the object (such as an approach associated with the object, how an object moved through an intersection, an approach an object used to enter an intersection, the approach an object used to exit an intersection, and so on), a time or number of frames since the object was last detected (and/or since first detected and so on), whether or not the object is moving, and so on.

Structured data and/or metrics for individual detected objects and/or other data (such as light phase, time, intersection position, and so on) determined using one or more frames and/or from one or more video feeds from one or more intersection cameras associated with one or more intersections may be used together to calculate various metrics, such as metrics associated with approaches. For example, structured data and/or metrics for individual detected objects associated with an approach identifier (which may be determined based on an association with the intersection camera from which frames of the video feed were obtained) may be aggregated and analyzed to determine one or more approach volumes (such as a number of vehicles (cars, motorbikes, trucks, buses, and so on)) in a particular approach, a number of light vehicles (such as cars, motorbikes, and so on) in a particular approach, a number of heavy vehicles (such as trucks, buses, and so on) in a particular approach, a number of cars in a particular approach, a number of trucks in a particular approach, a number of buses in a particular approach, a number of pedestrians in a particular approach, a number of non-motor vehicles in a particular approach, a number of bicycles in a particular approach, and so on), an average queue length (such as in feet and/or another unit of measurement) of a particular approach, and so on. By way of another example, light status in one or more frames may be tracked and/or correlated with other information to determine a light status, an effective green time (such as a length of time that objects are moving through a particular intersection), an effective red time (such as a length of time that objects are stopped at a particular intersection), a cycle time (such as a length of time that a light is green determined by comparing the light phase across multiple frames), a number of cars that arrived while a traffic light is green, a number of cars that arrived while a traffic light is red, a measure of individual phase progression performance derived from a percentage of vehicle volume arrivals on green, and so on.

Other structured data and/or metrics associated with approaches may be calculated. For example, a last stop time may be calculated based on a last time-stamp that an object stopped at an approach. By way of another example, a last start time may be calculated based on a last time-stamp that an object moved into the intersection at a particular approach. In other examples, an approach identifier for a particular approach may be determined, coordinates for a camera associated with a particular intersection may be determined, number of lanes associated with a particular approach may be determined, and so on.

Structured data and/or metrics for individual detected objects and/or other data (such as light phase, time, intersection position, and so on) determined using one or more frames and/or from one or more video feeds from one or more intersection cameras associated with one or more intersections may be also used together to calculate various metrics associated with intersections. For example, a vehicle volume for a particular intersection may be determined by summing objects (such as cars, motorbikes, trucks, buses, and so on) in all approaches of a frame associated with the intersection, a light vehicle volume for a particular intersection may be determined by summing objects (such as cars, motorbikes, and so on) in all approaches of a frame associated with the intersection, a heavy vehicle volume for a particular intersection may be determined by summing objects (such as trucks, buses, and so on) in all approaches of a frame associated with the intersection, a car volume for a particular intersection may be determined by summing cars in all approaches of a frame associated with an intersection, a truck volume for a particular intersection may be determined by summing trucks in all approaches of a frame associated with an intersection, a bus volume for a particular intersection may be determined by summing buses in all approaches of a frame associated with an intersection, a person volume for a particular intersection may be determined by summing people in all approaches of a frame associated with an intersection, a bicycle volume for a particular intersection may be determined by summing bicycles in all approaches of a frame associated with an intersection, arrivals on green in all approaches of a frame associated with an intersection, arrivals on red in all approaches of a frame associated with an intersection, a number of near misses in a frame associated with a particular intersection (which may be calculated based on positions of objects in the frame, such as based on the distance between the geometric centers of the bounding boxes associated with two objects being less than a threshold), a current frame when a light went red, a frame when a light went green, and so on.

Other information for an intersection may be determined using the video feed, frames, and/or other structured data and/or metrics. For example, an identifier for a camera associated with an intersection may be determined, identifiers for frames of one or more video feeds associated with the intersection may be determined, observation times associated with an intersection may be determined (such as a time-stamp based on ingestion time when other metadata from a stream or other video feed is not available, a cumulative time (such as from the start of processing of the video feed) may be determined, and so on.

Although determination and calculation of structured data and/or metrics relating to one or more vehicles and/or other objects, approaches, intersections, and so on are discussed above, it is understood that these are examples. In various examples, any structured data and/or metrics relating to one or more vehicles and/or other objects, approaches, intersections, and so on may be determined and calculated from the objects detected in one or more frames of one or more video feeds of one or more intersection cameras and/or other traffic data without departing from the scope of the present disclosure.

Alternatively and/or additionally to determining and/or calculating structured data and/or metrics from one or more video feeds from one or more intersection cameras and/or other traffic data, connected vehicle data may be obtained and used. For example, structured data and/or metrics may be determined and/or calculated using a combination of connected vehicle data and data from one or more video feeds from one or more intersection cameras and/or other traffic data. By way of another example, a visualization dashboard may visualize connected vehicle data along with structured data and/or metrics determined and/or calculated from one or more video feeds from one or more intersection cameras and/or other traffic data.

To summarize the above, real-time video feed from an intersection camera and/or other traffic data may be obtained. Objects in frames of the video feed may be detected and classified. Positions of the objects at various times in the frames of the video feed may be determined, as well as information such as light statuses related to the objects. Differences between the objects in different frames may be used to determine behavior of the objects over time. Such calculated object metrics may be stored, such as in one or more vehicle tables. Such calculated object metrics for objects that are associated with a particular approach may be aggregated in order to determine various approach object volumes and/or other metrics related to the approach, which may then be stored, such as in one or more approach tables. Further, such object metrics for objects that are associated with a particular intersection may be aggregated in order to determine various intersection object volumes and/or other metrics related to the intersection, which may then be stored, such as in one or more intersection tables.

The above structured data and/or metrics related to one or more vehicles and/or other objects, approaches, intersections, and so on discussed above may then be processed and/or otherwise prepared for visualization and/or one or more other purposes. For example, structured data and/or metrics related to one or more vehicles and/or other objects may be stored in one or more vehicle tables, structured data and/or metrics related to one or more intersections may be stored in one or more intersection tables, structured data and/or metrics related to one or more approaches may be stored in one or more approach tables, and so on. Such tables may then be used for visualization and/or one or more other purposes.

By way of illustration, a visualization dashboard may include a graphical model generated of a city or other area. The graphical model may include one or more intersections and may visualize various of the structured data and/or metrics to the depicted intersections and so on. In some examples, one or more intersections depicted by the graphical model may be selected to present various information related to the structured data and/or metrics associated with the intersection (such as arrival phase over an interval, average speed over an interval, various object volumes (such as right turn volume, left turn volume, through volume, and so on), approach data related to the intersection, how objects proceeded through the intersection, a current and/or historical video feed associated with the intersection, and so on). Various controls may be provided that enable a user to select which information is displayed, export data related to the information, playback historic data, and so on.

In other examples, the structured data and/or metrics may be used for purposes other than visualization. Example uses include, but are not limited to, adaptive traffic signal control, predicting traffic congestion and accidents, productizing aggregated data from multiple cities for private sector use (such as in the auto insurance, rideshare, logistics, autonomous vehicle original equipment manufacturer spaces, and so on), routing (such as for rideshare, logistics, autonomous vehicle control, and so on), simulating traffic, using structured data and/or metrics to simulate how changes to traffic (and/or traffic signals, traffic conditions, and so on) will change traffic patterns, and so on.

Although the above illustrates and describes performance of functions (such as detection and classification, determination of structured data, and so on) on frames of a raw, real-time video feed from an intersection camera and/or other traffic data, it is understood that this is an example. In various implementations, one or more such functions (and/or other functions) may be performed on other traffic data, such as data from one or more LiDAR sensors.

LiDAR sensors may be operable to determine data, such as ranges (variable distance), by targeting an object with elements, such as one or more lasers, and measuring the time for the reflected light to return to one or more receivers. LiDAR sensors may generate point cloud data that may be used for the analysis discussed herein instead of frames of a raw, real-time video feed from an intersection camera and/or other traffic data.

In some examples, functions similar to those described above performed on frames of a raw, real-time video feed from an intersection camera and/or other traffic data (such as detection and classification, determination of structured data, and so on) may be performed on the LiDAR sensor data. In other examples, structured data generated from LiDAR cloud data that has already been detected and classified may be obtained and various metrics may be calculated from such, similar to above, which may then be prepared for visualization and/or visualized and/or otherwise used similar to above.

LiDAR sensor data may have a number of advantages over frames of a raw, real-time video feed from an intersection camera and/or other traffic data. To begin with, point cloud data from one or more LiDAR sensors may not have the same privacy issues as frames of a raw, real-time video feed from an intersection camera and/or other traffic data as facial and/or other similar images may not be captured. Further, LiDAR sensor data may not be dependent on lighting and thus may provide more reliable data over all times of day and night as compared to frames of a raw, real-time video feed from an intersection camera and/or other traffic data. Additionally, LiDAR sensor data may provide data in three-dimensional space as opposed to the two-dimensional data from frames of a raw, real-time video feed from an intersection camera and/or other traffic data and thus may provide depth, which may not be provided via frames of a raw, real-time video feed from an intersection camera and/or other traffic data.

For example, a determination may be made about the size of an average vehicle in pixels. This may be used with the LiDAR sensor data to determine the pixels from the center of a vehicle represented in the LiDAR sensor data and then infer the speed of the vehicle. Compared to approaches using frames of a raw, real-time video feed from an intersection camera and/or other traffic data, an assumption may not have to be made about object speed. This may be more accurate, but also may improve the processing speed of computing devices processing the data as functions performed on frames of a raw, real-time video feed from an intersection camera and/or other traffic data to determine speed may not need to be performed and can be omitted since this information may already be represented in LiDAR sensor data. Various configurations are possible and contemplated without departing from the scope of the present disclosure.

Although the above illustrates and describes a number of examples where traffic is in the context of vehicular and/or non-vehicular traffic on streets, roads, and/or similar structures, it is understood that these are examples. In other examples, functions similar to those discussed above may be performed in the context of other kinds of traffic without departing from the scope of the present disclosure.

By way of a first example, pedestrian and/or other traffic through one or more parking lots, walkways, and/or other areas related to one or more events and/or event venues may be monitored, analyzed, directed, controlled, simulated, and so on. In another example, cargo in one or more container trucks moving in relation to one or more ports may be monitored, analyzed, directed, controlled, simulated, and so on. In still another example, cargo truck queues related to one or more ports may be monitored, analyzed, directed, controlled, simulated, and so on. In yet another example, various airport traffic (such as pedestrians and/or vehicles approaching an airport, moving through an airport, and so on) may be monitored, analyzed, directed, controlled, simulated, and so on. Various configurations are possible and contemplated without departing from the scope of the present disclosure.

The computing device 101 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The computing device 101 may include one or more processors 110 and/or other processing units and/or controllers, one or more non-transitory storage media 111 (which may take the form of, but is not limited to, a magnetic storage medium; optical storage medium; magneto-optical storage medium; read only memory; random access memory; erasable programmable memory; flash memory; and so on), one or more communication units 112 (such as one or more network adapters and/or other devices used by a device to communicate with one or more other devices), and/or other components. The processor 110 may execute instructions stored in the non-transitory storage medium 111 to perform various functions. Such functions may include interacting with the cloud computing arrangement 102 to obtain data from one or more traffic devices, process data in a data processing pipeline, and so on. Alternatively and/or additionally, the computing device 101 may involve one or more memory allocations configured to store at least one executable asset and one or more processor allocations configured to access the one or more memory allocations and execute the at least one executable asset to instantiate one or more processes and/or services, such as one or more services, and so on.

Similarly, the cloud computing arrangement 102 may include any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The computing device 101 may include one or more processors and/or other processing units and/or controllers, one or more non-transitory storage media (which may take the form of, but is not limited to, a magnetic storage medium; optical storage medium; magneto-optical storage medium; read only memory; random access memory; erasable programmable memory; flash memory; and so on), one or more communication units (such as one or more network adapters and/or other devices used by a device to communicate with one or more other devices), and/or other components. The processor may execute instructions stored in the non-transitory storage medium to perform various functions. Such functions may include interacting with the computing device 101 to obtain data from one or more traffic devices, process data in a data processing pipeline, and so on. Alternatively and/or additionally, the cloud computing arrangement 102 may involve one or more memory allocations configured to store at least one executable asset and one or more processor allocations configured to access the one or more memory allocations and execute the at least one executable asset to instantiate one or more processes and/or services, such as one or more services, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Although the system 100 is illustrated and described as including particular components arranged in a particular configuration, it is understood that this is an example. In a number of implementations, various configurations of various components may be used without departing from the scope of the present disclosure.

For example, the system 100 is illustrated and described as including the computing device 101 and the cloud computing arrangement 102. However, it is understood that this is an example. In various implementations, the system 100 may include the computing device 101 without the cloud computing arrangement 102 or vice versa. Various configurations are possible and contemplated without departing from the scope of the present disclosure.

Although the above illustrates and describes performance of functions like detection and classification, determination of structured data, and so on, it is understood that this is an example. In various implementations, one or more such functions may be omitted without departing from the scope of the present disclosure.

For example, in some implementations, data that has already been detected and classified may be obtained. Various metrics may be calculated from such, similar to above, which may then be prepared for visualization and/or visualized and/or otherwise used similar to above.

Although the above illustrates and describes predicting accidents and ameliorating predicted accidents, it is understood that this is an example. In some implementations, conditions other than accidents (such as near misses) may be predicted and/or ameliorated. Various configurations are possible and contemplated without departing from the scope of the present disclosure.

Although the system 100 is shown and described above as obtaining traffic data and weather data and predicting one or more accidents by correlating traffic data and weather data to historical traffic and weather accident data, it is understood that this is an example. In various embodiments, the system 100 may omit obtaining weather data and may predict one or more accidents by correlating traffic data to historical traffic data. In some embodiments, the system may obtain data other than traffic and weather data (such as scheduled event data, economic data, historical traffic data, and so on) and may predict one or more accidents by correlating traffic data and the other data to historical traffic and other data. Various configurations are possible and contemplated without departing from the scope of the present disclosure.

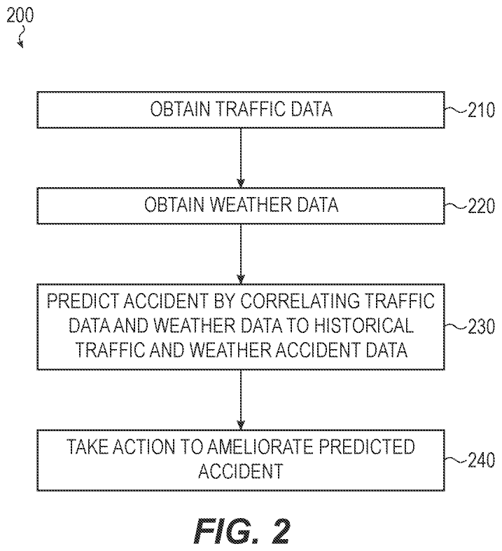

FIG. 2 depicts a flow chart illustrating a first example method 200 for ameliorating accidents predicted by correlating traffic and weather monitoring. This method 200 may be performed by the system of FIG. 1.

At operation 210, an electronic device (such as the computing device 101 of FIG. 1, one or more devices included in the cloud computing arrangement 102 of FIG. 1, and so on) may obtain traffic data. At operation 220, the electronic device may obtain weather data. The electronic device may obtain traffic and/or weather data from one or more traffic devices and/or from traffic data and/or weather data sources such as NYC Open Data, the National Centers for Environmental Information, and so on.

At operation 230, the electronic device may predict an accident by correlating traffic data and weather data to historical traffic and weather accident data. At operation 240, the electronic device may take an action to ameliorate a predicted accident.

For example, historical traffic and weather accident data may indicate that a particular intersection has a 65% higher likelihood of accidents corresponding to left turns when at least an inch of rain has fallen within the last half hour and traffic volume exceeds a certain amount. The electronic device may compare traffic and weather data to the historical traffic and weather accident data to determine that an inch of rain has fallen in the last half hour and the traffic volume exceeds the certain amount. In response, the electronic device may control traffic signals to reroute traffic from other intersections that lead into the particular intersection to reduce the traffic volume until the predicted likelihood of accidents decreases below a threshold, such as 15%.

By way of another example, historical traffic and weather accident data may indicate that a particular intersection has a 35% higher likelihood of accidents corresponding to stuck vehicles when ice is on the road. The electronic device may compare traffic and weather data to the historical traffic and weather accident data to determine that ice is on the roads. In response, the electronic device may route emergency services to be present in the vicinity in order to get vehicles unstuck and keep traffic moving.

In various examples, this example method 200 may be implemented as a group of interrelated software modules or components that perform various functions discussed herein. These software modules or components may be executed within a cloud network and/or by one or more computing devices, such as the computing device 101 of FIG. 1, one or more devices included in the cloud computing arrangement 102 of FIG. 1, and so on.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 illustrated obtaining traffic data and obtaining weather data as separate, linearly performed operations. However, it is understood that this is an example. In various implementations, such operations may be combined, performed in a different order, and so on. Various configurations are possible and contemplated without departing from the scope of the present disclosure.

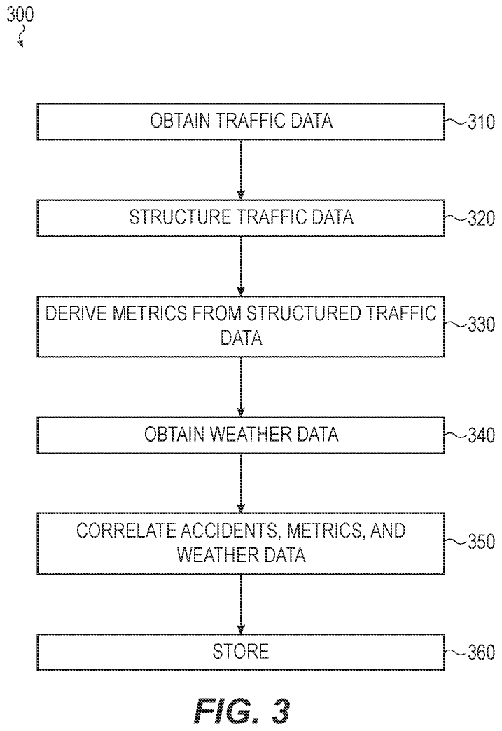

FIG. 3 depicts a flow chart illustrating a second example method 300 for ameliorating accidents predicted by correlating traffic and weather monitoring. This method 300 may be performed by the system of FIG. 1.

At operation 310, an electronic device (such as the computing device 101 of FIG. 1, one or more devices included in the cloud computing arrangement 102 of FIG. 1, and so on) may obtain traffic data. At operation 320, the electronic device may structure the traffic data. For example, a frame number may be determined for a frame, an intersection identifier may be determined for a frame, a unique tracker identifier may be assigned to each object detected, the class of the object may be determined (such as person, car, truck, bus, motorbike, bicycle, and so on), coordinates of the object detected in the frame may be determined (which may be determined with reference to known coordinates of the intersection and/or the intersection camera, such as camera longitude, latitude, city, state, country, and so on) (such as the minimum and maximum x positions of the object, the minimum and maximum y positions of the object, and so on), and the like.

At operation 330, the electronic device may derive metrics from structured traffic data. For example, the metrics may involve vehicle volume, vehicle volume by vehicle type, average speed, movement status, distance travelled, queue length, pedestrian volume, non-motor volume, light status on arrival, arrival phase, route through intersection, light times, near misses, longitude, latitude, city, state, country, and/or any other metrics that may be calculated using the structured data.

At operation 340, the electronic device may obtain weather data. At operation 350, the electronic device may correlate accidents, metrics, and weather data. At operation 360, the electronic device may store the correlated accidents, metrics, and weather data. The electronic device may store the correlated accidents, metrics, and weather data as traffic and weather accident data.

In various examples, this example method 300 may be implemented as a group of interrelated software modules or components that perform various functions discussed herein. These software modules or components may be executed within a cloud network and/or by one or more computing devices, such as the computing device 101 of FIG. 1, one or more devices included in the cloud computing arrangement 102 of FIG. 1, and so on.

Although the example method 300 is illustrated and described as including particular operations performed in a particular order, it is understood that this is an example. In various implementations, various orders of the same, similar, and/or different operations may be performed without departing from the scope of the present disclosure.

For example, in some implementations, the method 300 may include the additional operations of comparing current traffic and weather data to the stored correlated accidents, metrics, and weather data to determine whether or not an increased likelihood of accidents is indicated and/or ameliorating such accidents. Various configurations are possible and contemplated without departing from the scope of the present disclosure.

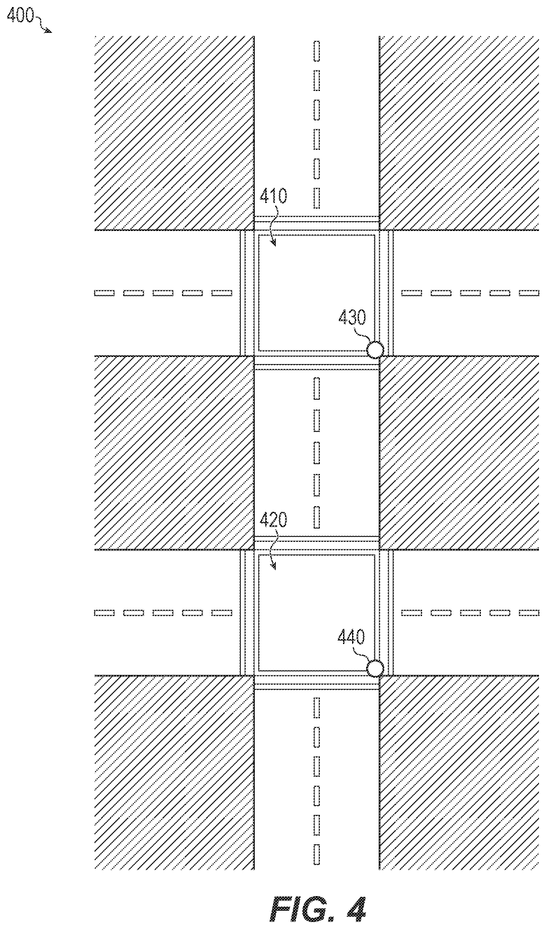

FIG. 4 depicts a group 400 of intersections 410, 420 with traffic monitoring devices 430, 440. Such traffic monitoring devices may include one or more intersection cameras, LiDAR sensors, and so on. Data from such traffic monitoring devices may be provided to the computing device 101 of FIG. 1, the cloud computing arrangement 102 of FIG. 1, and so on. Such data may be used for ameliorating accidents predicted by correlating traffic and weather monitoring.

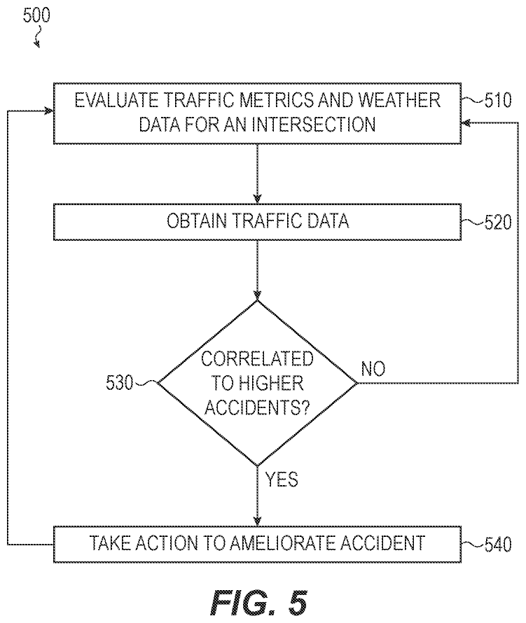

FIG. 5 depicts a flow chart illustrating a third example method 500 for ameliorating accidents predicted by correlating traffic and weather monitoring. This method 500 may be performed by the system of FIG. 1.

At operation 510, an electronic device (such as the computing device 101 of FIG. 1, one or more devices included in the cloud computing arrangement 102 of FIG. 1, and so on) may evaluate traffic metrics and weather data for an intersection. At operation 520, the electronic device may compare the traffic metrics and weather data for the intersection to historical data for the intersection.

At operation 530, the electronic device may determine whether or not the comparison of the traffic metrics and weather data for the intersection to historical data for the intersection correlates to higher accidents. If so, the flow may proceed to operation 540 where the electronic device may take action to ameliorate one or more of the predicted accidents. Otherwise, the flow may return to operation 510 where the electronic device may again evaluate traffic metrics and weather data for the intersection.

In various examples, this example method 500 may be implemented as a group of interrelated software modules or components that perform various functions discussed herein. These software modules or components may be executed within a cloud network and/or by one or more computing devices, such as the computing device 101 of FIG. 1, one or more devices included in the cloud computing arrangement 102 of FIG. 1, and so on.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is illustrated and described as determining whether or not the comparison of the traffic metrics and weather data for the intersection to historical data for the intersection correlates to higher accidents. However, it is understood that this is an example. In some implementations, conditions other than accidents (such as near misses) may be predicted and/or ameliorated. Various configurations are possible and contemplated without departing from the scope of the present disclosure.

In various implementations, a system for ameliorating accidents predicted by correlating traffic and weather monitoring may include a non-transitory storage medium that stores instructions and a processor. The processor may execute the instructions to obtain traffic data; structure the traffic data into structured data; derive metrics from the structured traffic data; obtain weather data; correlate accidents, the metrics, and the weather data to generate traffic and weather accident data; obtain current traffic data; obtain current weather data; predict an accident by correlating the current traffic data and the current weather data with the traffic and weather accident data; and take an action to ameliorate the accident.

In some examples, the action may include routing emergency services. In a number of examples, the action may include providing an alert. In various examples, the action may include controlling a traffic signal.

In a number of examples, the processor may predict the accident by determining that a particular intersection has an increased likelihood of the accident due to a correlation between a current weather condition and a current traffic condition. In some such examples the current weather condition may include a slick road. In a number of such examples, the current traffic condition may include a particular vehicle volume.

In some implementations, a system for ameliorating accidents predicted by correlating traffic and weather monitoring may include a non-transitory storage medium that stores instructions and a processor. The processor may execute the instructions to obtain traffic data, obtain weather data, predict an accident by correlating the traffic data and the weather data with historical traffic and weather accident data, and take an action to ameliorate the accident.

In a number of examples, the processor may generate the historical traffic and weather accident data using obtained data regarding traffic, weather, and accidents. In various examples, the action may include providing a visualization dashboard that depicts information associated with the accident.

In some examples, the processor may receive the traffic data from at least one traffic monitoring device. In a number of such examples, the at least one traffic monitoring device may include at least one of a still image, a video camera, and a light detection and ranging sensor. In some such examples, the system may include the at least one traffic monitoring device.

In various examples, the processor may use a cloud computing arrangement to analyze the traffic data.

In a number of implementations, a method for ameliorating accidents predicted by correlating monitoring may include obtaining traffic data using at least one processing unit, structuring the traffic data into structured data using the at least one processing unit, deriving metrics from the structured traffic data using the at least one processing unit, obtaining other data using the at least one processing unit, predicting an accident using the at least one processing unit by correlating the metrics and the other data with historical traffic and other accident data, and taking an action to ameliorate the accident using the at least one processing unit.

In various examples, the data may be weather data. In some examples, the metrics may include at least one of vehicle volume, average speed, movement status, distance travelled, queue length, pedestrian volume, non-motor volume, and light status on arrival. In a number of examples, the metrics may include at least one of arrival phase, route through intersection, light times, and near misses.

In some examples, the structuring the traffic data into the structured data may include identifying objects in one or more frames. In various examples, the deriving the metrics from the structured traffic data may include tracking objects between one or more frames.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to ameliorating accidents predicted by correlating traffic and weather monitoring. Traffic data and weather data may be obtained. One or more accidents may be predicted by correlating the traffic data and weather data to historical traffic and weather accident data. One or more actions may be then taken to ameliorate the accident. This may include providing one or more alerts regarding the accident, providing one or more visualizations regarding the accident and/or otherwise associated with the accident, controlling traffic signals, generating recommendations to change traffic systems, route emergency services, and/or otherwise act to ameliorate the accident.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for ameliorating accidents predicted by correlating traffic and weather monitoring, comprising:
a non-transitory storage medium that stores instructions; and
a processor that executes the instructions to:
obtain traffic data;
structure the traffic data into structured data;
derive metrics from the structured traffic data;
obtain weather data;
correlate accidents, the metrics, and the weather data to generate traffic and weather accident data;
obtain current traffic data;
obtain current weather data;
predict an accident by correlating the current traffic data and the current weather data with the traffic and weather accident data; and
take an action to ameliorate the accident.

2. The system of claim 1, wherein the action comprises routing emergency services.

3. The system of claim 1, wherein the action comprises providing an alert.

4. The system of claim 1, wherein the action comprises controlling a traffic signal.

5. The system of claim 1, wherein the processor predicts the accident by determining that a particular intersection has an increased likelihood of the accident due to a correlation between a current weather condition and a current traffic condition.

6. The system of claim 5, wherein the current weather condition comprises a slick road.

7. The system of claim 5, wherein the current traffic condition comprises a particular vehicle volume.

8. A system for ameliorating accidents predicted by correlating traffic and weather monitoring, comprising:
a non-transitory storage medium that stores instructions; and
a processor that executes the instructions to:
obtain traffic data;
obtain weather data;
predict an accident by correlating the traffic data and the weather data with historical traffic and weather accident data; and
take an action to ameliorate the accident.

9. The system of claim 8, wherein the processor generates the historical traffic and weather accident data using obtained data regarding traffic, weather, and accidents.

10. The system of claim 8, wherein the action comprises providing a visualization dashboard that depicts information associated with the accident.

11. The system of claim 8, wherein the processor receives the traffic data from at least one traffic monitoring device.

12. The system of claim 11, wherein the at least one traffic monitoring device comprises at least one of a still image, a video camera, and a light detection and ranging sensor.

13. The system of claim 11, wherein the system includes the at least one traffic monitoring device.

14. The system of claim 8, wherein the processor uses a cloud computing arrangement to analyze the traffic data.

15. A method for ameliorating accidents predicted by correlating monitoring, comprising:
obtaining traffic data using at least one processing unit;
structuring the traffic data into structured data using the at least one processing unit;
deriving metrics from the structured traffic data using the at least one processing unit;
obtaining other data using the at least one processing unit;
predicting an accident using the at least one processing unit by correlating the metrics and the other data with historical traffic and other accident data; and
taking an action to ameliorate the accident using the at least one processing unit.

16. The method of claim 15, wherein the other data comprises weather data.

17. The method of claim 15, wherein the metrics include at least one of vehicle volume, average speed, movement status, distance travelled, queue length, pedestrian volume, non-motor volume, and light status on arrival.

18. The method of claim 15, wherein the metrics include at least one of arrival phase, route through intersection, light times, and near misses.

19. The method of claim 15, wherein the structuring the traffic data into the structured data comprises identifying objects in one or more frames.

20. The method of claim 15, wherein the deriving the metrics from the structured traffic data comprises tracking objects between one or more frames.
